(19) United States
(12) Patent Application Publication
(10) Pub. No.: US 2007/0085907 A1
(43) Pub. Date: Apr. 19, 2007

(54) Video storage uplink system

(75) Inventor: John P. Beauregard, Belmont, MI (US)

Correspondence Address: FOLEY AND LARDNER LLP;SUITE 500, 3000 K STREET NW, WASHINGTON, DC, 20007, US

(73) Assignee: SMITHS AEROSPACE LLC

(21) Appl. No.: 11/249,264

(22) Filed: Oct. 14, 2005

(51) Int. Cl. H04N 7/18

(52) U.S. Cl. 348/144

(57) ABSTRACT

A video storage uplink system includes a controller, a power input, an external input, a first and second memory partition, a switching interface, a communications unit and a data retrieval interface. The external camera input is configured to receive image data acquired by a plurality of video cameras mounted to the exterior of an aircraft. The switching interface is configured to receive airborne status signals from a squat switch mounted to the landing gear. The first memory partition stores image data received when the aircraft is on the ground. The second memory partition stores image data received when the aircraft is airborne. The communications unit is configured to transmit image data stored in the first and second memory partition. Alternatively, the data retrieval interface, provides access to data stored in the first and second memory partition via a physical connector. Using crash protected solid state memory partitions allow data retrieval for air or ground accident investigations.

### BACKGROUND

The present invention generally relates to the field of electronic data management. Specifically, the present invention relates to aircraft video recording and surveillance. Aircraft manufacturers have used video cameras to monitor the interior and exterior of aircraft for several years. Commercial aircraft have many areas suitable for video surveillance, such as the cockpit or the passenger cabin. In addition, commercial aircraft may have video cameras mounted to the hull, the wings or other exterior surfaces. For instance, aircraft manufacturers typically place video cameras underneath the fuselage. Video cameras underneath the fuselage are useful because a pilot's vision in the cockpit is limited and video cameras mounted under the fuselage can capture images that will assist a pilot during taxi procedures. For example, the External and Taxi Aid Camera System (“ETACS”), developed by Latecoere for the AirBuS™ A380™ uses five external video cameras. The image data from those cameras is relayed to a cockpit display to assist the crew during ground maneuvering. In addition, aircraft manufacturers have placed video cameras on other exterior locations of the aircraft to monitor ground activities such as refueling and cargo loading.

Generally, a multiplexer accepts a feed from both the exterior and interior video cameras. The multiplexer processes the video feeds and outputs the signals to a monitor. As previously described, a pilot or crewmember may view the monitor to acquire visual information about the exterior or interior of the aircraft. For example, the commercially available Concentrator and Multiplexer for Video (“CMV”) unit provides switching and video manipulation to facilitate the display of various video functions on primary cockpit displays. Inputs may include taxi aid video, cockpit door surveillance, smoke detection video (in the cargo and avionics bay), cabin video and airport navigation graphics.

In known commercial applications, the flight crew makes extensive use of exterior video cameras to monitor pre-takeoff procedures and to guide the aircraft while it is on the ground. However, once the aircraft is airborne, the flight crew aboard a commercial aircraft does not use the external video feed. Therefore, a system and method that will use the exterior video cameras on an aircraft in a more efficient and productive manner is desirable.

### SUMMARY

According to one embodiment of the invention, a video storage uplink system for a commercial aircraft comprises a controller, a power input configured to receive power from the aircraft's power source, an external camera input, operably coupled to the controller, configured to receive image data acquired by a plurality of video cameras mounted to the exterior of the aircraft, a switching interface configured to receive airborne status signals from a weight-on-wheels squat switch mounted to the landing gear of the aircraft, a first memory partition for storing image data received through the external input when the aircraft is on the ground, a second memory partition for storing image data received through the external input when the aircraft is airborne, a communications unit, operably coupled to the controller, configured to receive control signals and transmit image data stored in the first or second memory partition and a data retrieval interface, operably coupled to the controller, configured to provide access to data stored in the first memory partition and the second memory partition via a physical connector.

According to another embodiment of the invention, a method for conducting military aerial surveillance using a commercial aircraft, comprises the steps of providing a plurality of video cameras mounted to the exterior of the aircraft, receiving image data from each of the plurality of video cameras and determining whether the aircraft is airborne. If the aircraft is not airborne, the received image data is stored in a first memory partition for commercial use. In the alternative, if the aircraft is airborne, the received image data is stored in a second memory partition for military use.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a top view of an aircraft having a video storage uplink system and external video cameras, according to one embodiment of the invention.

FIG. 2 is a side view of an aircraft having a video storage uplink system and external video cameras, according to one embodiment of the present invention.

FIG. 3 is a block diagram of a video storage uplink system, according to one embodiment of the invention.

FIG. 4 is a flowchart illustrating the operation of a video storage uplink system, according to one embodiment of the invention.

FIG. 5 is a detailed input flow diagram according to one embodiment of the invention.

FIG. 6 is a detailed output flow diagram according to one embodiment of the invention.

### DETAILED DESCRIPTION

Embodiments of the present invention will be described below with reference to the accompanying drawings. It should be understood that the following description is intended to describe exemplary embodiments of the invention, and not to limit the invention.

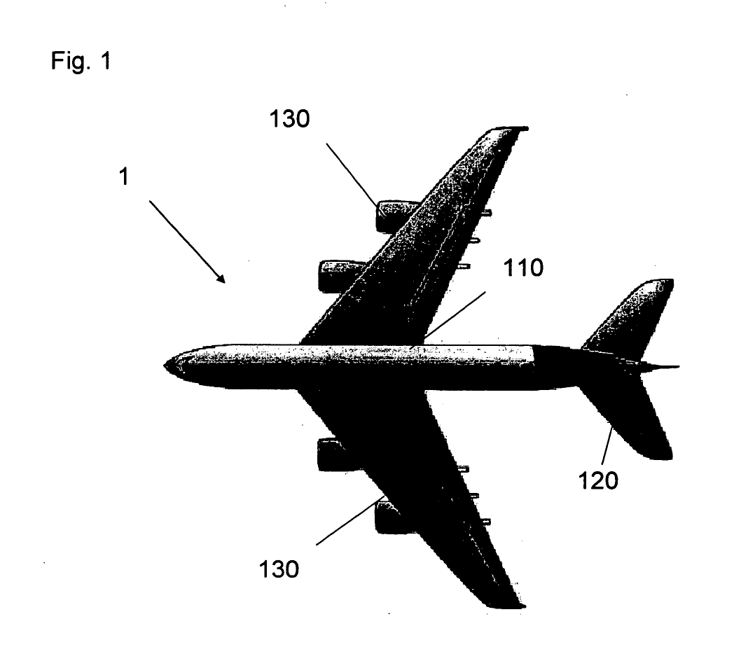

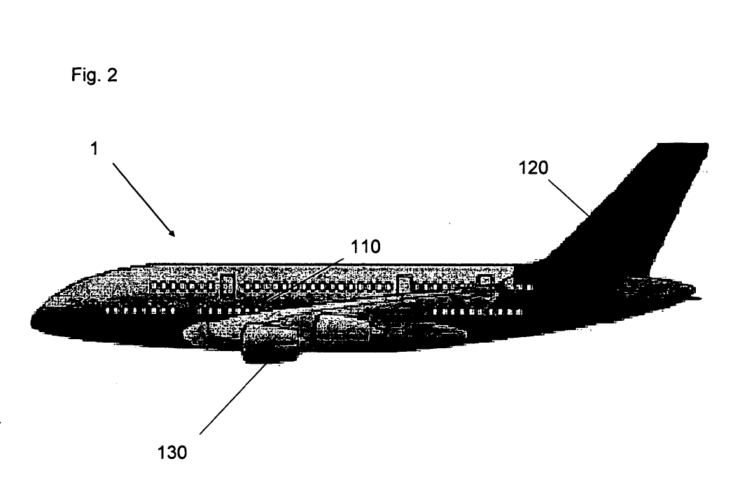

FIG. 1 is a top view of an aircraft 1 that may have external cameras 100 (not shown) mounted to its exterior. According to one embodiment of the invention, an aircraft 1 may have anywhere from one to seven external video cameras 100. For example, referring to FIGS. 1 and 2, an external camera 100 may be located under the fuselage 110 of the aircraft 1. Another external camera 100 may be mounted on the vertical tail fin 120 of the aircraft 1. Yet another external camera 100 may be mounted on the wings 130 of the aircraft 1. Preferably, the external cameras 100 are made from lightweight materials and are designed to compliment the aircraft 1 aerodynamically to reduce drag.

The external cameras 100 are configured to provide a range of views. For example, a camera 100 mounted under the fuselage 110 may be configured to provide a 360° view underneath the aircraft 1. In the alternative, an external camera 100, mounted underneath the fuselage 110, may be configured to provide a single view directly underneath the aircraft 1. In addition, an external camera 100, mounted to the vertical tail fin 120, may provide a wide-angle view of the aircraft 1 from one wing tip to the opposite wing tip. According to one embodiment of the invention, the external cameras 100 may be equipped with various lenses to provide wide angle and telephoto views. Further, the external cameras 100 may possess zoom capabilities that allow for the magnification of images. The external cameras 100 may also possess numerous features including focus control, freeze frame capabilities and the ability to operate in low light. According to another embodiment of the invention, the external cameras 100 are the cameras used by the Airbus™ A380™ ETAC system.

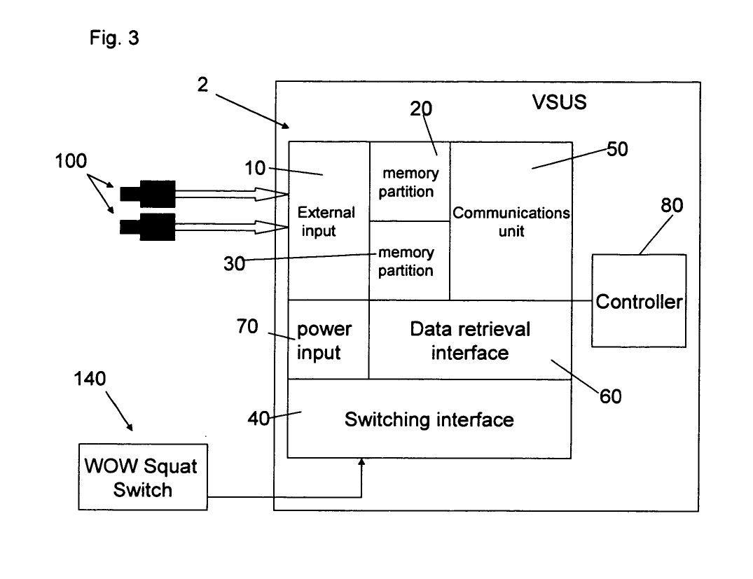

According to one embodiment of the present invention, a plurality of external video cameras 100 are operably coupled to a Video Storage Uplink System (“VSUS”) 2. Primarily, the VSUS 2 is configured to accept and store the video feed from the external cameras 100. The external video cameras 100 may be connected to the VSUS 2 via cable, fiber optic wire or other known commercial means. FIG. 3 is a block diagram of the VSUS 2. As show in FIG. 3, the VSUS 2 comprises an external input 10, a first memory partition 20, a second memory partition 30 and a switching interface 40. In addition, the VSUS 2 comprises a communications unit 50, a data retrieval interface 60 and a power input 70. All of the above components may be operably coupled to a controller 80. The controller 80 is configured to operate the above-described components and to run software for collecting and processing aircraft operational information.

The VSUS 2 may be built so that the stored video information can be recovered in case of an accident. The VSUS 2 memory partitions may be housed in a crash survivable casing and tested in accordance with government regulations for data recorders, such as FAA TSO-C124a. In addition, the crash survivable casing may be attached to an underwater locator beacon (ULB) to assist in the location of the VSUS in the event of an accident over water.

In the alternative, the VSUS 2 may be enclosed in a housing with one or more growth slots and may be located anywhere in the aircraft. According to one embodiment of the invention, the growth slots may be populated with video playback channels and additional video, audio, high-speed data buses, and data recording interfaces.

As shown in FIG. 3, the external input 10 is configured to accept the video feed from a plurality of external video cameras 100 via cable, coaxial cable, fiber optic wire or other commercial means. Generally, the external input 10 is an interface that may accept both digital and analog video feeds. In one embodiment of the invention, the external input 10 is implemented using a commercially available Concentrator and Multiplexer for Video (“CMV”) interface. The CMV unit provides switching and video manipulation to display various video functions on cockpit displays in an aircraft 1. According to another embodiment of the invention, the external input 10 may interface the external cameras 100 via a digital interface or via RS-170 NTSC/S video input channels.

As shown in FIG. 3, the VSUS 2 comprises a first and second memory partition 20, 30. The first memory partition 20 stores images captured by the external cameras 100 when the aircraft 1 is located on the ground. For example, all video data captured by an external video camera 100 during taxiing procedures, prior to takeoff or after landing, is stored in the first memory partition 20. In the alternative, the second memory partition 30 stores image data captured by external cameras 100 while the aircraft 1 is airborne. Due to the various types of external cameras 100 and the wide range of mounting options, various aerial video images can be captured and stored while the aircraft 1 is airborne. For example, the second memory partition 30 may store aerial images of the ground or the airspace surrounding the aircraft 1.

According to one embodiment of the invention, the first and second memory partitions 20, 30 may be configured to store video image data in integrated circuit memory chips and nonvolatile solid state flash memory. In addition, solid state technology is preferred because it requires the use of less “moving parts” than other technologies. In turn, maintenance costs of the VSUS 2 are significantly reduced.

The switching interface 40 will now be described. Typically, a weight-on-wheels “WOW” squat switch 140 is mounted to the landing gear of an aircraft 1. According to one embodiment of the present invention, the switching interface 40 acquires an airborne status signal from the WOW squat switch 140. For example, when the aircraft 1 is on the ground, the WOW squat switch 140 is in an open electrical state. While the WOW squat switch 140 is in the open electrical state, a signal is received by the switching interface 40 and sent to the controller 80 indicating that the aircraft 1 is on the ground. In turn, the video images captured by the external cameras 100 are stored in the first memory partition 20.

When the aircraft 1 becomes airborne and weight is no longer being applied on the landing gear, the WOW squat switch 140 is set to a closed or “ground” state. While the WOW squat switch 140 is in a closed electrical state, a signal is received by the switching interface 40 and sent to the controller 80 indicating that the aircraft 1 is off the ground. Subsequently, the video images captured by the external cameras 100 are stored in a second memory partition 30. According to another embodiment of the invention, the switching interface 40 is configured to receive an airborne status signal from another avionics system onboard the aircraft 1.

In sum, using the switching interface 40, the controller 80 can automatically indicate which memory partition 20, 30 is to be used for storing the external video data. This arrangement allows for efficient access to both ground and aerial footage.

As shown in FIG. 3, the VSUS 2 also comprises a communications unit 50. The communications unit 50 is capable of transmitting and receiving data signals. For example, the communications unit 50 is capable of transmitting video images stored in the first or second memory partitions 20, 30 to a receiver (not shown). According to one embodiment of the invention, the communications unit 50 is a satellite communications system. The receiver may be a ground communications receiver, a receiver on an Airborne Warning and Control System (“AWACS”) aircraft or a receiver on a communications satellite. Further, the communications unit 50 may be used to receive external control signals. For example, an air traffic control tower may access the communications unit 50 to initiate download of the video images stored on either memory partition 20, 30.

As shown in FIG. 3, the VSUS 2 also comprises a data retrieval interface 60. The data retrieval interface 60 facilitates the download of video information stored in the first or second memory partition 20, 30 via a physical connector. Various types of commercially available networking devices may be used to connect to the data retrieval interface 60. For example, an Ethernet connection may be used to connect to the data retrieval interface 60. Then, the video data captured in each of the first and second memory partitions 20, 30 may be downloaded to another device such as a personal computer or miniature handheld device using the Ethernet connection. According to another embodiment of the invention, the data retrieval interface may only be accessed when the aircraft 1 is on the ground by enabling the data retrieval interface 60 only when the WOW squat switch 140 is in the open electrical state. This measure protects the stored video images from physical tampering during flight.

FIG. 3 also shows that a power input 70 is included in the VSUS 2. The power input 70 is configured to receive power from an aircraft power supply (not shown). According to one embodiment of the invention, the power input 70 is configured for 28V DC. In another embodiment of the invention, the VSUS 2 is configured to use an independent or backup power supply. The independent power supply enables the VSUS 2 to continue data collection in the event of a power loss.

As shown in FIG. 3, each of the components described above is operably coupled to a controller 80. The controller 80 is also configured to send and receive control signals to each component of the VSUS 2. The controller 80 may be comprised of, for example, a central processing unit (“CPU”), random access memory (“RAM”) and read only memory (“ROM”). The controller 80 is configured to execute software for collecting and processing aircraft operational information. Such information may include, but is not limited to, time stamp data and geographical positioning data. This data can supplement the video images captured and stored by the VSUS 2 in order to provide a detailed account of an aircraft's 1 position and surroundings. In addition, the controller 80 may be configured to stop all data storage when altitude is above a certain altitude such as 10,000 feet, for example, or configured to prevent data retrieval via the communication unit 50 by requiring a password, or configured to prevent data retrieval via a physical connector by requiring a known input.

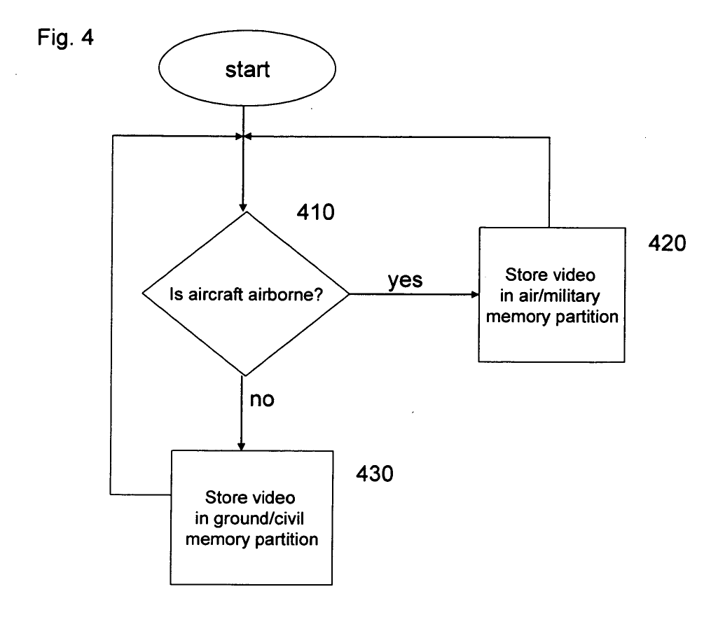

The operation of the VSUS 2 will now be described briefly with reference to FIG. 4. In step 410, the controller 80 determines whether the aircraft 1 is airborne. According to one embodiment of the invention, when an aircraft 1 is airborne, the WOW squat switch 140 is in a closed electrical state. In this state, the controller 80 receives a signal via the switching interface 40 indicating that the aircraft 1 is airborne. Accordingly, all video footage received through the external input 10 is stored in a dedicated “air” memory partition (Step 420). According to one embodiment of the invention, the second memory partition 30 stores all video data acquired by the external cameras 100 when the aircraft 1 is airborne.

In the alternative, when an aircraft 1 is on the ground, the WOW squat switch 140 is in an open electrical state. In this state, the controller 80 receives a signal via the switching interface 40 indicating that the aircraft 1 is not airborne. Accordingly, all video footage received through the external input 10 is stored in a dedicated “ground” memory partition (Step 430), whereby the video data is also provided to the cockpit for viewing by the pilot. According to one embodiment of the invention, the first memory partition 20 stores all video data acquired by the external cameras 100 when the aircraft 1 is on the ground.

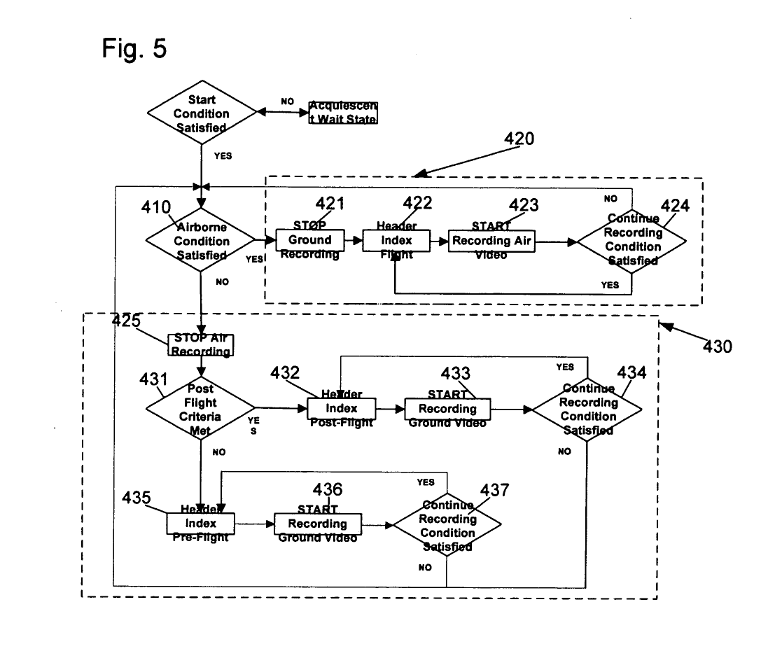

FIG. 5 is a input flow diagram according to one embodiment of the invention. As shown in step 410, if the aircraft 1 is airborne then the controller video footage captured by the eternal video cameras 100 is no longer stored in the dedicated “ground” memory partition (Step 421). The controller 80 then creates a header for indexing airborne video footage (Step 422). Then, video footage captured by the external cameras 100 is stored in the “dedicated” air memory partition 30 (Step 423). The controller 80 then checks and determines whether certain conditions are satisfied such that video footage may be continued to be stored in the dedicated air memory partition 30 (Step 424). If the condition of step 424 is satisfied then the header is updated as shown in step 422. If the condition of step 424 is not satisfied then the controller 80 executes step 410. If the controller 80 determines that the aircraft 1 is not airborne, the controller 80 ceases to store video footage in the dedicated air memory partition 30 (Step 425).

As shown in FIG. 5 and in step 431, the controller 80 determines whether the aircraft 1 is in post-flight mode (just landed) or in preflight mode (preparing for takeoff). If the aircraft 1 is in post flight mode a header for indexing the post flight ground video footage is created (Step 432). Then, video footage captured by the external cameras 100 is stored in the dedicated ground memory partition 20 (Step 433). The controller 80 then checks and determines whether certain conditions are satisfied such that video footage may be continued to be stored in the dedicated ground memory partition 20 (Step 434). If this condition is satisfied then the header is updated (Step 432). If not, the controller executes step 410. In the alternative, if the aircraft 1 is in preflight mode then a header for indexing preflight ground video data is created (Step 435). Next, video footage captured by the external cameras 100 is stored in the dedicated ground memory partition 20 (Step 436). The controller 80 then checks and determines whether certain conditions are satisfied such that video footage may be continued to be stored in the dedicated ground memory partition 20 (Step 437). If this condition is satisfied then the header is updated (Step 436). If not, the controller executes step 410.

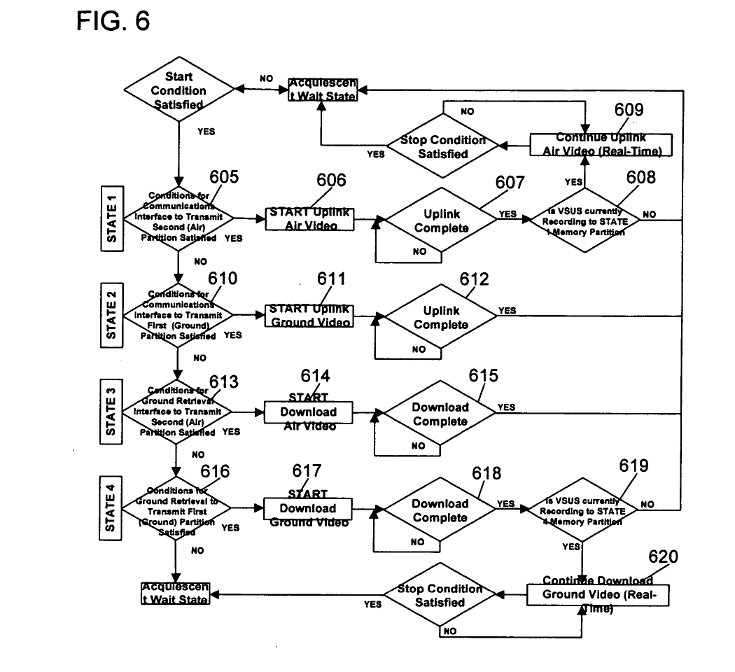

FIG. 6 is a flow diagram illustrating how the memory partitions 20, 30 may be accessed via the communications unit 50 or data retrieval interface 60. In step 605 and 606, if the controller determines that video footage stored in the dedicated air memory partition 30 may be transmitted via the communications unit 50, the communications unit 50 uplinks the stored video footage to a receiver. The controller continuously monitors whether the uplink is complete (Step 607). The controller 80 also determines whether video footage is presently being stored in the dedicated air memory partition 30 (Step 608). If video footage is presently being stored in the dedicated air memory partition 30, then the controller 80 also uploads the video footage in real-time through the communications unit 50 (Step 609).

In step 610 and 611, if the controller determines that video footage stored in the dedicated ground memory partition 20 may be transmitted via the communications unit 50, the communications unit 50 uplinks the stored video footage to a receiver. The controller continuously monitors whether the uplink is complete (Step 612).

In step 613 and 614, if the controller determines that video footage stored in the dedicated air memory partition 30 may be transmitted via the data retrieval interface 60, the data retrieval interface 60 downloads the stored video footage to a device configured to connect to the data retrieval interface 60. The controller continuously monitors whether the download is complete (Step 615).

In step 616 and 617, if the controller determines that video footage stored in the dedicated ground memory partition 20 may be transmitted via the data retrieval interface 60, the data retrieval interface 60 downloads the stored video footage to a device configured to connect to the data retrieval interface 60. The controller continuously monitors whether the download is complete (Step 618). The controller 80 also determines whether video footage is presently being stored in the dedicated ground memory partition 20 (Step 619). If video footage is presently being stored in the dedicated ground memory partition 20, then the controller 80 also provides the video footage real-time through the data retrieval interface 60 (Step 620).

According to certain aspects of the present invention, several advantages are realized. One advantage of the present invention is that it provides for the safe collection and storage of video images recorded during ground operations. The VSUS 2 provides for the recording of aircraft ground handling procedures and provides actual video of foreign object debris damage during ground taxiing procedures. Depending on configuration of aircraft cameras 100 and their installation, the VSUS 2 is capable of capturing video during taxiing procedures while providing the pilot with ground roll assistance, capturing video of refueling and cargo loading procedures, and capturing ground roll “Foreign Object Damage.” In addition, the VSUS provides the capability for maintenance or pilot training using stored video footage and may be populated with video playback channels for on-aircraft pre flight and post flight activity reviews. Moreover, the VSUS's 2 compatibility with commercially known products allows it to integrate seamlessly with commercial avionics systems.

Another advantage of the present invention is that it provides access to stored aerial video images. The VSUS 2 can provide an uplink to a maintenance hub or air traffic receiver. When the VSUS 2 is populated with video playback channels, commercial aircraft operators can utilize the VSUS 2 while airborne, based on the configuration of aircraft cameras 100, to view the airworthiness of the aircraft and detect conditions such as a blown tire, gear position, foreign object damage, operability of control surfaces, engine operation, wing leading edge conditions, and the tail area status. In addition, this VSUS may provide a method for inspection following takeoff after an event such as engine fire, bird strike or lightning strike for the purpose of determining the aircraft's condition for continued safe flight and landing. In addition, the images recorded by external video cameras 100 on an airborne aircraft 1 may be of interest to accident investigators, intelligence or military agencies. Aerial footage can be accessed via the communications unit 50 or may be accessed via the data retrieval interface 60. Thus, a military or intelligence entity may access the VSUS 2 to obtain video surveillance information in real-time or physically access the data when the aircraft 1 is on the ground. For example, the VSUS 2 may be used to obtain aerial video images for domestic surveillance missions. Similarly, the military could access video images taken by a commercial aircraft 1 flying over opposition targets located in civilian areas. Thus, the present invention provides military and intelligence agencies access to aerial video surveillance via a commercial aircraft 1.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. Specifically, the VSUS 2 is not restricted to use in only commercial or military applications. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A video storage uplink system comprising:
a controller;
an external camera input, operably coupled to the controller, configured to receive image data;
a first memory partition for storing image data received through the external camera input;
a second memory partition for storing image data received through the external camera input;
a switching interface configured to receive airborne status signals from a weight-on-wheels squat switch mounted to the landing gear of the aircraft and transmit the airborne status signals to the controller;
a communications unit operably coupled to the controller;
a power input, configured to receive power from an aircraft power source; and
a data retrieval interface, operably coupled to the controller, configured to provide access to data stored in the first memory partition and the second memory partition.

2. The video storage uplink system of claim 1, wherein the communications unit is configured to transmit stored image data to a receiver and receive signals from a transmitter.

3. The video storage uplink system of claim 1, wherein the power input is configured to receive power at 28 V DC.

4. The video storage uplink system of claim 1, wherein the data retrieval interface is configured to accept an Ethernet connection.

5. The video storage uplink system of claim 1, wherein the external input receives image data from a plurality of video cameras mounted on the exterior of an aircraft.

6. The video storage uplink system of claim 5, wherein the first memory partition stores image data captured by each of the plurality of external cameras when the aircraft is on the ground.

7. The video storage uplink system of claim 5, wherein the second memory partition stores image data captured by each of the plurality of external cameras when the aircraft is airborne.

8. The video storage uplink system of claim 1, wherein the controller further comprises software for collecting and processing aircraft operational information.

9. The video storage uplink system of claim 1, wherein the switching interface is operably coupled to the weight-on-wheels squat switch.

10. The video storage uplink system of claim 1, wherein the first and second memory partitions are comprised of solid state flash memory and are configured to store digital video data within a crash protected casing.

11. A video storage uplink system for conducting military surveillance with a commercial aircraft comprising:
a controller;
a power input, configured to receive power from the aircraft's power source;
a plurality of video cameras mounted to the exterior of the aircraft;
an external camera input, operably coupled to the controller, configured to receive image data acquired by the plurality of video cameras mounted to the exterior of the aircraft;
a switching interface configured to receive airborne status signals from a weight-on-wheels squat switch mounted to the landing gear of the aircraft and transmit the airborne status signals to the controller;
a first memory partition for storing image data received through the external camera input when the aircraft is on the ground;
a second memory partition for storing image data received through the external camera input when the aircraft is airborne;
a communications unit, operably coupled to the controller, configured to receive control signals and transmit image data stored in the first or second memory partition; and
a data retrieval interface, operably coupled to the controller, configured to provide access to data stored in the first memory partition and the second memory partition via a physical connector.

12. A method for conducting aerial surveillance using a commercial aircraft comprising the steps of:
providing a at least one video camera mounted to the exterior of the aircraft;
receiving image data from the at least one video camera;
determining whether the aircraft is airborne;
if the aircraft is not airborne, storing the received image data in a first memory partition;
if the aircraft is airborne, storing the received image data in a second memory partition; and
transmitting the image data stored in a second memory partition to a receiver that is not disposed on the aircraft.

13. A method for conducting aerial surveillance using a commercial aircraft as claimed in claim 12, wherein the image data stored in the first memory partition is ground video data used for commercial applications and the image data stored in the second memory partition is airborne video data used for military applications.

14. A method for conducting accident investigation using a commercial aircraft comprising the steps of:
providing a at least one video camera mounted to the exterior of the aircraft;
receiving image data from the at least one video camera;
determining whether the aircraft is airborne;
if the aircraft is not airborne, storing the received image data in a first memory partition; and
if the aircraft is airborne, storing the received image data in a second memory partition,
wherein the first and second memory partitions are configured to survive a crash.
